(19) United States
(12) Patent Application Publication
(10) Pub. No.: US 2005/0089237 A1
(43) Pub. Date: Apr. 28, 2005

(54) Method and apparatus for bezier curve approximation data compression

(76) Inventors: Jaehwa Park, San Jose, CA (US); Manjirnath A. Chatterjee, Sunnyvale, CA (US); Charles Wang, Aliso Viejo, CA (US)

Correspondence Address: MOTOROLA INC, 600 NORTH US HIGHWAY 45, ROOM AS437, LIBERTYVILLE, IL, 60048-5343, US

(21) Appl. No.: 10/692,618

(22) Filed: Oct. 24, 2003

(51) Int. Cl. G06K 9/36

(52) U.S. Cl. 382/242

(57) ABSTRACT

A method (400) and apparatus (1000) for compressing digital ink such as a hand-drawn object (104) are provided. The hand-drawn object is first prepared (406, 1010) and then Bezier curves based upon the hand-drawn object are generated (408, 1012). The Bezier curve representation (202) of the hand-drawn object (104) is further compressed (418, 1018) by modifying Bezier control points to produce a compressed Bezier curve representation (302) of the hand-drawn object (104).

### FIELD OF THE INVENTION

The present invention generally relates to a method and an apparatus for data compression, more specifically to a method and apparatus for compressing Bezier curve approximation data.

### BACKGROUND OF THE INVENTION

Recently, small handheld computing devices, such as personal digital assistants (“PDAs”), have become increasingly popular. Due to their sizes, these handheld computing devices are typically not equipped with full-size keyboards. Some of these handheld computing devices support the use of the full-size keyboards as external attachments, and others offer reduced size keypads. Instead of providing a keyboard as an input interface, however, a typical handheld computing device provides a large display, occupying a substantial proportion of the handheld computing device, which is capable of displaying information as well as being capable of functioning as an input interface. Entering data through the display is generally accomplished by utilizing a writing instrument such as a pen or stylus, and a user typically enters information or data by directly writing on the display using the pen. Resulting hand-drawn objects, such as free-hand drawings, geometric shapes, and handwritten letters and characters, are captured as digital ink, and paths the pen has taken appear on the display. The digital ink represents coordinates and time information of the paths which the pen has taken to produce the hand-drawn objects on the display. Digital ink is typically expressed as poly line objects in series of pen points (x,y,t).

A small computing device utilizing digital ink typically samples points along each path the pen has taken at a predetermined frequency to approximate the path and the object drawn. However, data of the sampled points contain large amount of redundancy and can quickly become very large, which requires a large memory in the small computing device to store the data. If the user then wishes to transfer the data to another device, the transfer time may be unreasonably long due to the size of the date and the transfer rate available to the small computing device. This transfer time duration becomes even more apparent considering that due to the mobile and portable nature of the small computing device, the small computing device is likely to be connected to another device through a wireless network such as a cellular network, which has a relative narrow bandwidth, or a low rate of data transfer. To reduce the size of the data, the small computing device may perform data compression on the data of the sampled points, and then transmit the compressed data to the other device through the available network. The compressed data received by the other device is decompressed to recreate the object originally drawn. If the decompressed data is the same as the original data of the sampled points, then the compression-decompression process is said to be lossless; that is, no information has been lost due to the compression-decompression process. However, if the decompressed data is different from the original data of the sampled points, even slightly, then the compression-decompression process is said to be lossy; that is, some information has been lost due to the compression-decompression process.

Although a lossless process is preferred for an accurate representation, it is often unnecessary to reproduce the drawn object with the accuracy of the lossless process. It is often more desirable to reduce the data size for a reasonable and adequate representation of the object drawn than to maintain the large data size for the accurate reproduction of the drawn object.

### BRIEF DESCRIPTION OF THE DRAWINGS

FIG. 1 is an exemplary electronic device displaying a hand-drawn object;

FIG. 2 is an exemplary electronic device displaying a Bezier curve approximation of the hand-drawn object and Bezier control points;

FIG. 3 is an exemplary device displaying a representation of the hand-drawn object using an exemplary data compression process and Bezier control points;

FIG. 4 is a flowchart illustrating an exemplary process of compressing digital ink;

FIG. 5 is an exemplary illustration of a visual comparison between the hand-drawn object and the final representation of the hand-drawn object;

FIG. 6 is a flowchart illustrating an exemplary process of dividing digital ink into smaller digital ink strokes;

FIG. 7 is an exemplary illustration of Bezier curve and straight line approximations;

FIG. 8 is a flowchart illustrating an exemplary process of determining whether a Bezier curve can be adequately represented by a straight line;

FIG. 9 is a flowchart illustrating an exemplary process of modifying Bezier control points for further reduction in data size; and

FIG. 10 is an exemplary block diagram of an electronic device according to the present invention.

### DETAILED DESCRIPTION OF THE PREFERRED EMBODIMENTS

The present invention generally relates to a method and an apparatus for data compression, more specifically to a method and apparatus for compressing Bezier curve approximation data. An object, typically a hand-drawn object on a display of an electronic device such as a PDA, is a collection of points on the display, and the collection is referred as digital ink. The digital ink representing the object is first broken into smaller segments, or strokes, and each of these strokes is then approximated by a Bezier curve, which comprises Bezier control points. Each Bezier curve is then examined to determine whether it can be adequately represented by a straight line based upon a first predetermined condition. The Bezier curves, which meet the first predetermined condition, are replaced by straight lines. The Bezier curves, which fail to meet the first predetermined condition, are then examined to determine whether they can be better represented by modifying the corresponding Bezier control points. The Bezier curves, which fail to meet the first predetermined condition but are determined to be better represented by modifying the corresponding Bezier control points, receive modified Bezier control points.

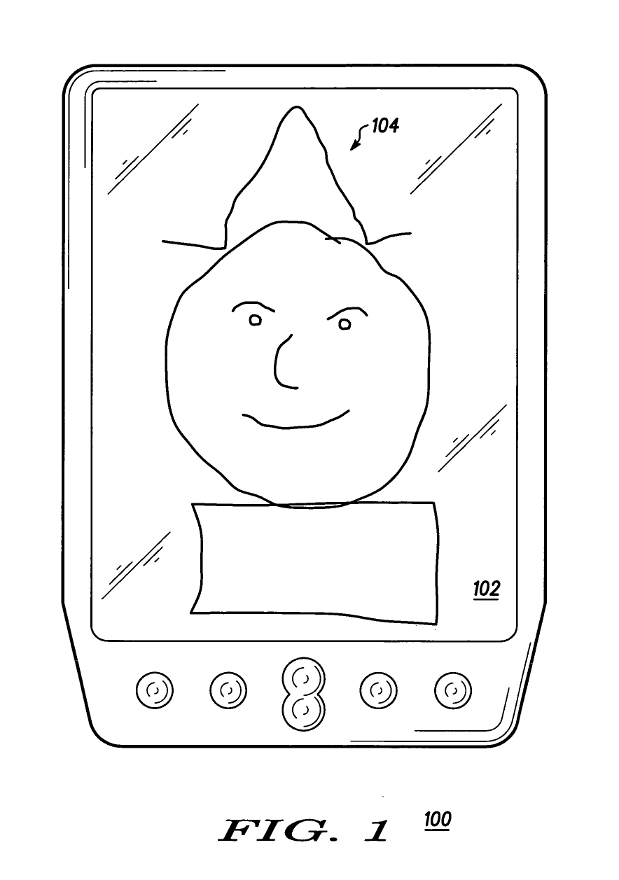

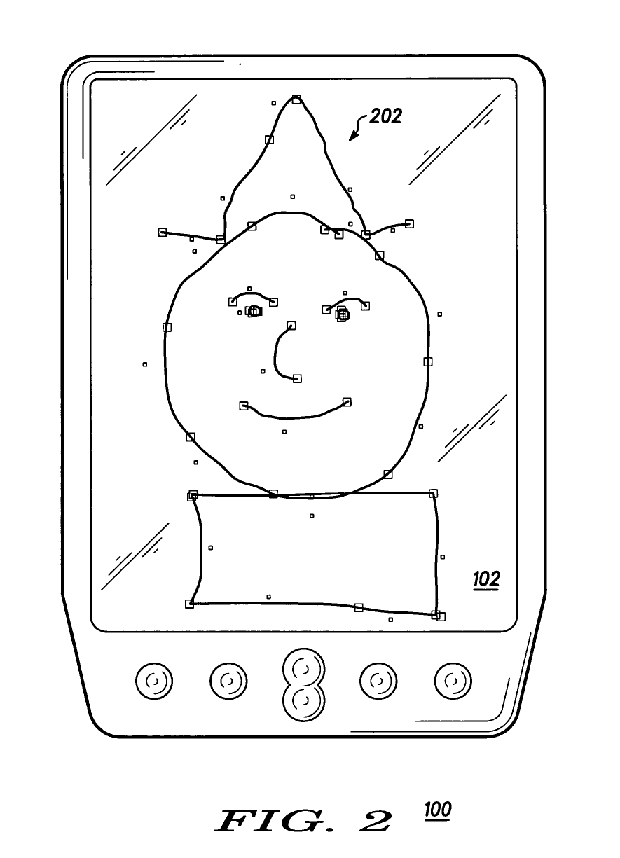

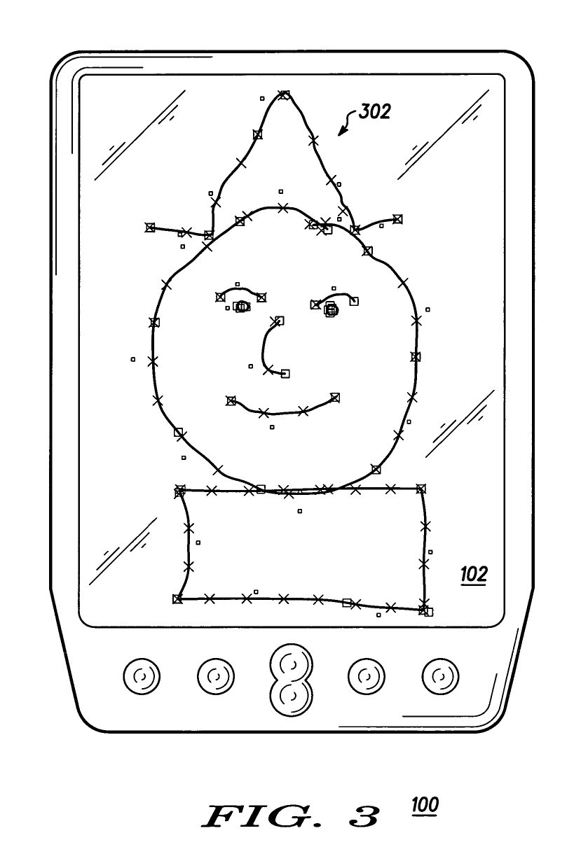

FIG. 1 is an exemplary electronic device 100 having a display 102 displaying a hand-drawn object 104, which is a representation by digital ink comprising digital ink points. FIG. 2 is the electronic device 100 displaying a Bezier curve approximation 202 of the hand-drawn object 104 on the display 102, and Bezier control points (only six Bezier control points are indicated, 204, 206, 208, 210, 212, and 214). FIG. 3 is the electronic device 100 displaying a final representation 302 of the hand-drawn object 104 on the display 102 using the presently described method, and Bezier control points (only six Bezier control points are indicated, 304, 306, 308, 310, 312, and 314).

FIG. 4 is a flowchart 400 illustrating an exemplary process of compressing digital ink. The process begins in block 402, and a delta size for the digital ink points is selected in block 404. The delta size is used to select consecutive points for approximating the digital ink. In block 406, the digital ink representing the entire hand-drawn object 104 is divided into a set of smaller digital ink strokes, and then each of the digital ink strokes is approximated by using a quadratic Bezier curve approximation in block 408. As a result of this approximation step, each digital ink stroke is now approximated and represented by a Bezier curve having Bezier control points. The Bezier control points are two on-line points where a corresponding approximated line goes through and at least one off-line point where curvature of the corresponding approximated line is controlled. As previously described, the resulting approximation 202 is shown in FIG. 2. At this point, a data size of a first compressed data representing the digital ink based upon the quadratic Bezier curve approximation may be calculated.

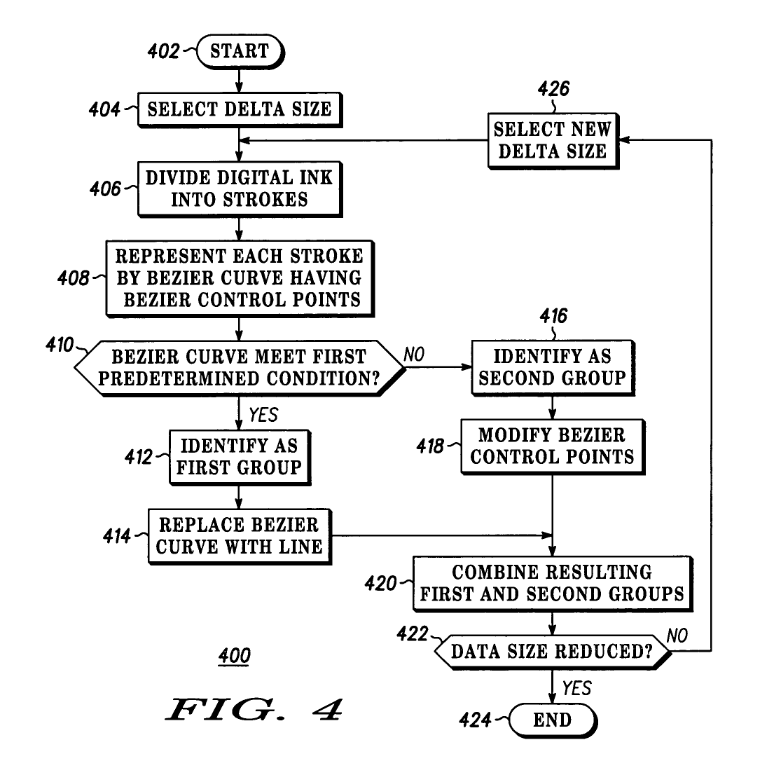

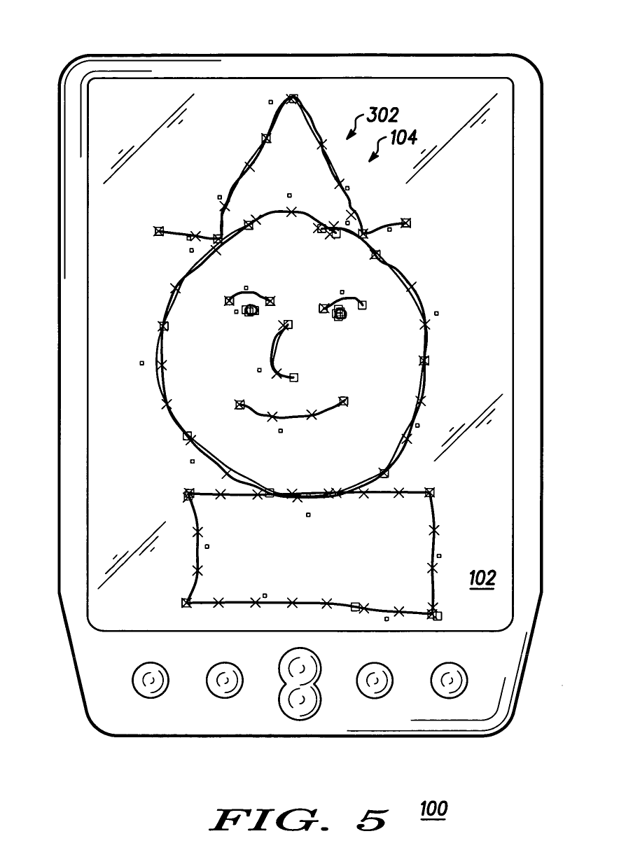

Each Bezier curve is then examined to determine whether it can be adequately represented by a straight line in block 410. The Bezier curves that are determined to be adequately representable by straight lines are grouped into a first group of the Bezier curves in block 412, and the Bezier curves of the first groups are re-represented with straight lines to approximate the corresponding digital strokes in block 414. The Bezier curves that are determined not to be adequately representable by straight lines are grouped into a second group of the Bezier curves in block 416. The Bezier control points of the Bezier curves of the second group are evaluated and modified in block 418. Resulting first and second groups are then combined to determine a data size of a second compressed data in block 420. The second compressed data size is then compared to the first compressed data size to determine whether a desired compression is achieved in block 422. If the desired compression is achieved, then the process terminates in block 424. As previously described, the resulting final approximation 302 is shown in FIG. 3. However, if the desired compression is not yet achieved, then a new delta size is selected in block 426, and the process is repeated from block 406. After the desired compression is achieved, the second compressed data may be losslessly compressed for further activities such as storage in memory and transmission to another device. FIG. 5 is an exemplary illustration of a visual comparison between the originally drawn object 104 and the final approximation 302, which is overlaid on the originally drawn object 104.

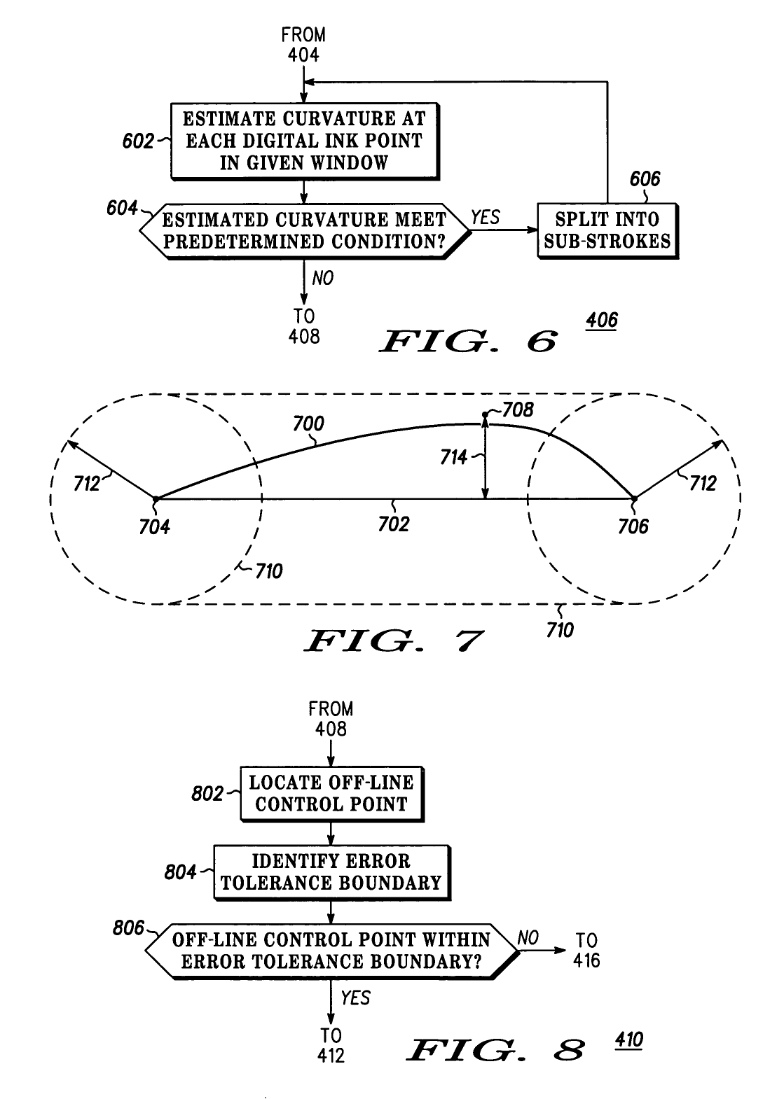

FIG. 6 is a flowchart illustrating an exemplary process of dividing digital ink into smaller digital ink strokes of block 406. In block 602, curvature at each digital ink point within a predetermined size window is estimated by averaging all curvature values at each digital ink point within the predetermined size window. In block 604, the estimated curvature value is compared against a predetermined threshold curvature value. Because high curvature points such as sharp turns are typically difficult to handle for curve fitting, a digital stroke having an estimated curvature value greater than the threshold curvature value is assumed to contain a sharp turn, and is split into sub-strokes in block 606. The process is repeated from block 602 based on the sub-strokes. If the estimated curvature is determined to be less than the predetermined threshold curvature value, then the digital ink stroke is assumed to be smooth enough, and the process continues to block 408.

After each stroke is represented by the Bezier curve with Bezier control points in block 408, fitting error and dynamic range of the control points may be checked. The Euclidian distance between actual ink point and corresponding point of the Bezier curve is assumed to be the fitting error. The dynamic range of control points is measured by a minimum bit size which can hold the maximum value of difference between consecutive two control points. If the fitting error and the dynamic range are greater than a predetermined acceptable ranges, then new splitting points are determined using a lower curvature threshold, and the process may be repeated from block 602 with the lower curvature threshold.

If the curvature is not large, then a Bezier curve may be adequately represented by a replacement straight line. FIG. 7 is an exemplary illustration of a Bezier curve 700, which is being considered in block 410 for determining whether it can be adequately represented by a straight line 702. The Bezier curve 700 has on-line control points 704 and 706, an off-line control point 708, and an error tolerance boundary 710. The error tolerance boundary is defined by an error tolerance 712, which is a radial distance originating from an on-line control point. A Euclidian distance 714 is shown as the distance between the off-line control point 708 and the straight line 702. FIG. 8 is a flowchart 800 illustrating an exemplary process of block 410 of determining whether the Bezier curve 700 can be adequately represented by a straight line 702. In block 802, the off-line Bezier control point 708 of the Bezier curve 700 is located. In block 804, the error tolerance boundary 710 defined by the error tolerance 712 is identified, and whether the off-line control point 708 is within the error tolerance boundary 710 is determined. If the off-line control point 708 is determined to be within the error tolerance boundary 710, then the process continues to block 412. If the off-line control point 708 is determined not to be within the error tolerance boundary 710, then the process continues to block 416. For example, the off-line control point 708 may be assumed to be within the error tolerance boundary 710 if the Euclidian distance 714 is less than the error tolerance 712. The Bezier curves having the off-line control points within respective error tolerance boundaries are replaced with straight line representations in block 414.

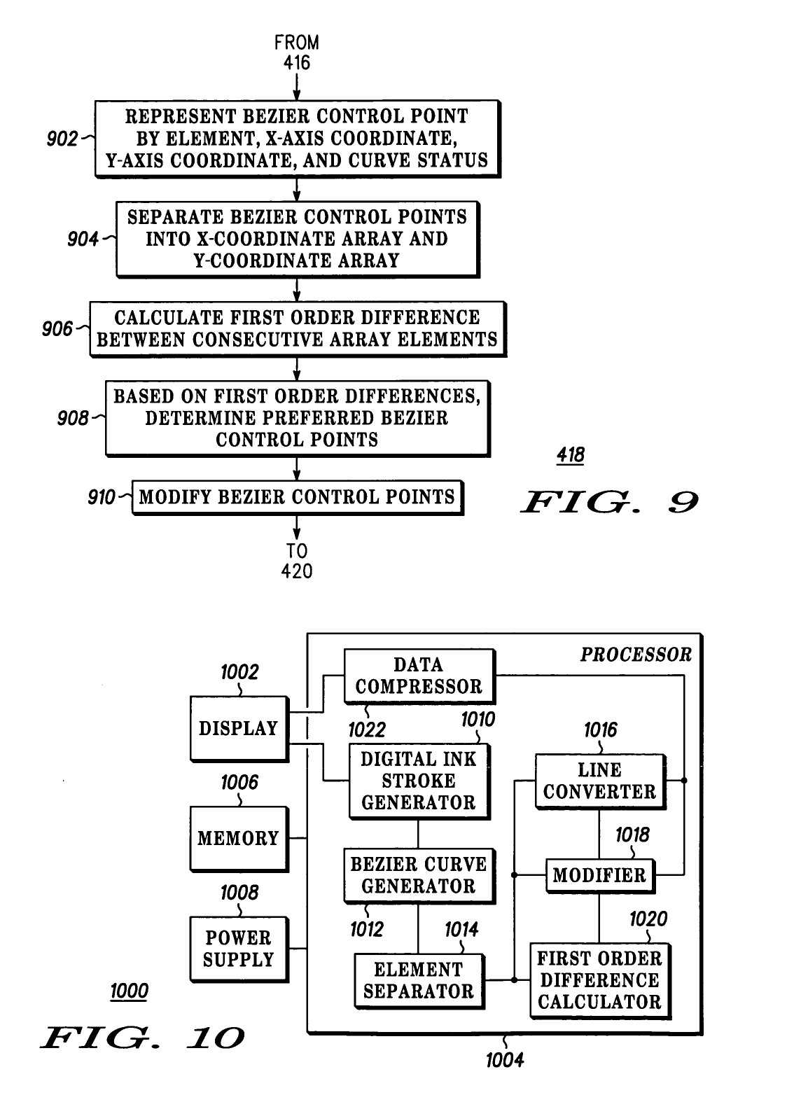

The Bezier curves determined not have the off-line control points within their respective error tolerance boundaries in block 410, i.e. the Bezier curves that cannot be adequately represented by straight lines, are further examined to reduce the total data size by modifying the on-line and off-line control points in block 418. FIG. 9 is a flowchart illustrating an exemplary process of block 418 of modifying Bezier control points for further reduction in data size. In block 902, each Bezier control point is represented by the corresponding element identification, an X-axis coordinate, a Y-axis coordinate, and a curve status. The element identification identifies which Bezier curve the Bezier control point belongs to, the X-axis and Y-axis coordinates represent the coordinates of the Bezier control point on the display, and the curve status indicates whether the Bezier control point is an on-line control point or an off-line control point. In block 904, the Bezier control points are separated and grouped into X-coordinate array and Y-coordinate array, with each element of the arrays identified by the corresponding element identification and the corresponding coordinate. In block 906, first order difference vectors are calculated for consecutive array elements in each array. Based on the first order differences calculated in block 906, the Bezier control points are separated into a preferred group, which is determined to perform well under entropy compression, and a non-preferred group in block 908. This determination may be made by re-representing the first order difference vectors of each array into magnitude and sign vectors, calculating a histogram of the magnitude vectors in each array, and keeping a certain predetermined percentage of best histogram values. In block 910, the Bezier control points of the non-preferred group of are re-represented inserting an additional on-line control point, inserting an additional off-line control point, deleting an existing on-line control point, deleting an existing off-line control point, perturbing an existing on-line control point, or perturbing an existing off-line control point. The process then continues to block 420.

FIG. 10 is an exemplary block diagram of an electronic device 1000 according to the present invention. The electronic device may be, but is not limited to, a radio telephone such as a cellular telephone, a personal digital assistant (“PDA”), a hand-held computer, or any computing and/or communicating device. The electronic device 1000 comprises a display 1002, a processor 1004, a memory 1006, and a power supply 1008. The processor 1004 has internal modules including a digital ink stroke generator 1010, a Bezier curve generator 1012, an element separator 1014, a line converter 1016, a modifier 1018, a first order difference calculator 1020, and a data compressor 1022. The power supply 1008 is controlled by the processor 1004 to provide power to the internal components so that they may function properly.

The display 1002 displays a drawn object. Data representing the drawn object may be imported to the electronic device 1000 from another device, or if the display 1002 is a touch pad, a user may draw on the display 1002 to provide the drawn object. The display may also display a resulting object approximating the drawn object based upon the compressed data. The processor 1004 then captures the drawn object on the display 1002 as digital ink. Once the drawn object is captured as digital ink, the digital ink stroke generator 1010 divides the captured digital ink into a series of strokes. The Bezier curve generator 1012 then converts each stroke into a corresponding Bezier curve characterized by Bezier control points. The element separator 1014 evaluates each Bezier curve and separates the Bezier curves into first and second groups based upon a predetermined condition. The first group of Bezier curves, satisfying the first predetermined condition, is deemed to be adequately representable by straight lines, and the line converter 1016 converts the first group of Bezier curves into corresponding straight lines. The second group of Bezier curves is evaluated for further compression. Each Bezier control point has a corresponding element identification, an X-axis coordinate, a Y-axis coordinate, and a curve status, where the X-axis and Y-axis coordinates represent coordinates of the Bezier control point on the display and the curve status indicates whether the Bezier control point is on-line control point or off-line control point. The first order difference calculator 1020 separates the coordinate information into an X-coordinate array and a Y-coordinate array and stores them into the memory 1006. The first order difference calculator 1020 calculates first order differences between consecutive array elements of each coordinate array to determine whether to perform further data compression. Based upon the calculated results of the first order difference calculator 1020, the modifier 1018 adjusts the existing Bezier control points in several ways to reduce the overall data size. The modifier 1018 may adjust the existing Bezier control points by inserting additional on-line control points, by inserting additional off-line control points, by deleting some of existing on-line control points, by deleting some of existing off-line control points, by perturbing some of existing on-line control points, by perturbing some of existing off-line control points, or by any combination of the above. The data compressor 1022 then losslessly compresses the combined data of the converted first group, which are approximations by straight lines, and the modified second group, which are approximations by modified Bezier curves.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method in an electronic device for compressing digital ink, the digital ink comprising a plurality of digital ink points representing a drawn object on a display, the method comprising:
dividing the digital ink into a plurality of digital ink strokes;
representing each of the plurality of digital ink strokes with a corresponding approximation element based upon quadratic Bezier curve approximation, the corresponding approximation element comprising an element identification and Bezier control points;
separating the corresponding approximation elements of the plurality of digital ink strokes into first and second groups of approximation elements based upon a first predetermined condition, the first group of approximation elements satisfying the first predetermined condition and the second group of approximation elements not satisfying the first predetermined condition;
converting each approximation element of the first group of approximation elements into a corresponding line approximation segment to obtain a converted first group of elements; and
re-representing each approximation element of the second group of approximation elements based upon a second predetermined condition to obtain a re-represented second group of elements.

2. The method of claim 1, further comprising:
compressing losslessly the converted first group of approximation elements and the re-represented second group of approximation elements.

3. The method of claim 1, wherein dividing the digital ink into a plurality of digital ink strokes divides the digital ink based upon a predetermined delta size.

4. The method of claim 3, further comprising:
determining a first data size comprising all of the quadratic Bezier curve approximations;
determining a second data size comprising the converted first group of approximation elements and re-represented second group of approximation elements;
selecting a new delta size if the second data size is greater than the first data size; and
repeating the steps of claim 1.

5. The method of claim 1, wherein dividing the digital ink into a plurality of digital ink strokes, for each of the plurality of digital ink strokes further comprises:
estimating curvature at each digital ink point of the digital ink stroke;
comparing the estimated curvature to a predetermined curvature condition; and
splitting the digital ink stroke into a set of corresponding sub-strokes if the estimated curvature of the digital ink stroke satisfies the predetermined curvature condition.

6. The method of claim 5, wherein estimating curvature at each digital ink point of the digital ink stroke is based upon an average of all estimated curvatures within a window, the window fixing a number of digital ink points permissible within the window.

7. The method of claim 1, wherein the Bezier control points comprise first and second on-line control points and an off-line control point.

8. The method of claim 7, wherein the first predetermined condition includes an error tolerance boundary for each digital ink stroke for determining whether the off-line control point of the digital ink stroke is within the error tolerance boundary.

9. The method of claim 8, wherein converting each approximation element of the first group of approximation elements into a corresponding line approximation segment converts each approximation element by representing each approximation element of the first group of approximation elements only by on-line control points of each approximation element of the first group of approximation elements.

10. The method of claim 7, wherein each Bezier control point is represented by the element identification of the corresponding approximation element, an X-axis coordinate, a Y-axis coordinate, and a curve status, the X-axis and Y-axis coordinates representing coordinates of the display, the curve status indicative of the Bezier control point being one of an on-line control point and an off-line control point.

11. The method of claim 10, wherein re-representing each element of the second group of elements based upon a second predetermined condition further comprises:
creating an X-coordinate array having X-coordinate array elements, each X-coordinate array element of the X-coordinate array partially representing a corresponding Bezier control point identified by the element identification and the X-axis coordinate of the Bezier control point;
creating a Y-coordinate array having Y-coordinate array elements, each Y-coordinate array element of the Y-coordinate array partially representing a corresponding Bezier control point identified by the element identification and the Y-axis coordinate of the Bezier control point; and
calculating first order differences between consecutive array elements of each coordinate array.

12. The method of claim 11, wherein re-representing each element of the second group of elements based upon a second predetermined condition is based upon the calculated first order differences between consecutive array elements of each coordinate array.

13. The method of claim 12, further comprising modifying the representation of each element of the second group by at least one of:
inserting an additional on-line control point;
inserting an additional off-line control point;
deleting an existing on-line control point;
deleting an existing off-line control point;
perturbing an existing on-line control point; and
perturbing an existing off-line control point.

14. An electronic device capable of compressing digital ink representing a drawn object, the electronic device comprising:
a display configured to display the drawn object;
a processor coupled to the display, the processor configured to capture the drawn object on the display as digital ink; and
a memory circuit coupled to the processor,
wherein the processor comprises:
a digital ink stroke generator configured to divide the digital ink into a plurality of digital ink strokes;
a Bezier curve generator coupled to the digital ink stroke generator, the Bezier curve generator configured to generate Bezier control points based upon quadratic Bezier curve approximation, the Bezier control points representing approximation elements, each approximation element having a unique corresponding digital ink stroke in the plurality of digital ink strokes;
an element separator coupled to the Bezier curve generator, the element separator configured to separate the approximation elements into first and second groups based upon a first predetermined condition;
a line converter coupled to the element separator, the line converter configured to convert each approximation element of the first group into a corresponding line approximation segment;
a modifier coupled to the element separator, the modifier configured to re-represent each approximation element of the second group based upon a second predetermined condition; and
a data compressor coupled to the line converter and the modifier, the data compressor configured to compress a combined data of the converted first group and the re-represented second group.

15. The electronic device of claim 14, wherein the display is a touch pad further configured to accept an input signal representing the drawn object drawn on the display.

16. The electronic device of claim 15, wherein the display is further configured to display an object based upon the compressed combined data representing the drawn object.

17. The electronic device of claim 14, wherein each Bezier control point is represented by a corresponding element identification, an X-axis coordinate, a Y-axis coordinate, and a curve status, the X-axis and Y-axis coordinates representing coordinates of the display, the curve status indicative of the Bezier control point being one of on-line control point and off-line control point.

18. The electronic device of claim 17, where in the memory circuit is configured to store an X-coordinate array having X-coordinate array elements, each X-coordinate array element of the X-coordinate array partially representing a corresponding Bezier control point identified by the element identification and the X-axis coordinate of the Bezier control point, and a Y-coordinate array having Y-coordinate array elements, each Y-coordinate array element of the Y-coordinate array partially representing a corresponding Bezier control point identified by the element identification and the Y-axis coordinate of the Bezier control point.

19. The electronic device of claim 18, wherein the processor further comprises a first order difference calculator coupled to the element separator and the modifier, the first order difference calculator configured to calculate first order differences between consecutive array elements of each coordinate array.

20. The electronic device of claim 19, wherein the second predetermined condition is based upon the calculated first order differences between consecutive array elements of each coordinate array.

21. A method in an electronic device for compressing a Bezier curve approximation, the Bezier curve approximation having a plurality of approximation elements, each approximation element represented by corresponding Bezier control points comprising first and second on-line control points and an off-line control point, each approximation element identified by an element identification, the method comprising:
separating the plurality of approximation elements into first and second groups of approximation elements based upon a first predetermined condition, the first group of approximation elements satisfying the first predetermined condition and the second group of approximation elements not satisfying the first predetermined condition;
converting each approximation element of the first group of approximation elements into a corresponding line approximation segment to obtain a converted first group of elements;
re-representing each approximation element of the second group of approximation elements based upon a second predetermined condition to obtain a re-represented second group of elements; and
compressing losslessly the converted first group of approximation elements and the re-represented second group of approximation elements.

22. The method of claim 21, wherein the first predetermined condition includes an error tolerance boundary for each approximation element of the plurality of approximation elements for determining whether the off-line control point of the digital ink stroke is within the error tolerance boundary.

23. The method of claim 22, wherein converting each approximation element of the first group of approximation elements into a corresponding line approximation segment converts each approximation element by representing each approximation element of the first group of approximation elements only by on-line control points of each approximation element of the first group of approximation elements.

24. The method of claim 21, wherein each Bezier control point is represented by the element identification of the approximation element which the Bezier control point represents, an X-axis coordinate, a Y-axis coordinate, and a curve status, the X-axis and Y-axis coordinates representing coordinates of the display, the curve status indicative of the Bezier control point being one of an on-line control point and an off-line control point.

25. The method of claim 24, wherein re-representing each approximation element of the second group of approximation elements based upon a second predetermined condition further comprises:
creating an X-coordinate array having X-coordinate array elements, each X-coordinate array element of the X-coordinate array partially representing a corresponding Bezier control point identified by the element identification and the X-axis coordinate of the Bezier control point;
creating a Y-coordinate array having Y-coordinate array elements, each Y-coordinate array element of the Y-coordinate array partially representing a corresponding Bezier control point identified by the element identification and the Y-axis coordinate of the Bezier control point; and
calculating first order differences between consecutive array elements of each coordinate array.

26. The method of claim 25, wherein re-representing each element of the second group of elements based upon a second predetermined condition is based upon the calculated first order differences between consecutive array elements of each coordinate array.

27. The method of claim 26, further comprising modifying the representation of each element of the second group by at least one of:
inserting an additional on-line control point;
inserting an additional off-line control point;
deleting an existing on-line control point;
deleting an existing off-line control point;
perturbing an existing on-line control point; and
perturbing an existing off-line control point.
